(19) United States
(12) Patent Application Publication
(10) Pub. No.: US 2003/0030923 A1
(43) Pub. Date: Feb. 13, 2003

(54) Optical system

(76) Inventors: Chuan-Yu Hsu, Hsinchu (TW); Chih-Wen Huang, Hsinchu (TW)

Correspondence Address: J.C. Patents, Inc., Suite 250, 4 Venture, Irvine, CA, 92618, US

(21) Appl. No.: 09/990,993

(22) Filed: Nov. 13, 2001

(30) Foreign Application Priority Data
Aug. 10, 2001 (TW) 89105447A01

(51) Int. Cl. G02B 26/08

(52) U.S. Cl. 359/857; 359/212

(57) ABSTRACT

An optical system device with a concave mirror, applicable for a scanner, comprising at least a curved reflection mirror and an image sensor. The curved reflection mirror is used for reflecting an image from an object to the image sensor. The curved reflection mirror can comprise a concave surface or a convex surface or both. At least a planar reflection mirror is located between the object and the curved reflection mirror, and is used to adjust a reflection angle and a reflection position of the image.

### CROSS-REFERENCE TO RELATED APPLICATION

This application claims the priority benefit of Taiwan application serial no. 89105447A01, filed Aug. 10, 2001.

### BACKGROUND OF THE INVENTION

1. Field of Invention

The present invention relates generally to an image optical system. More particularly, the present invention relates to an optical system using a concave mirror in a scanner.

2. Description of the Related Art

Most image optical system devices utilize a set of transparent lens to transfer an actual image of an object into a scale image that has a size fitting to an image sensor device.

FIG. 1A illustrates a schematic view showing an arrangement using a transparent lens. Referring to FIG. 1A, a convex mirror 100 has two focal points, 106 and 108 on its both sides. An object 102 is located on one side of the convex mirror 100, and an image of the object 102 is reflected by the convex mirror 100 to form another image 104 on other side of the convex mirror 100. This kind of technique is commonly applied in various types of image optical systems. For example, FIG. 1B shows a schematic view of a conventional optical system used in a scanner. The main purpose of the optical system in the scanner is to capture an image produced by lighting a document 140 and to transmit the image of the document 140 to an image sensor 132. An optical system 136 comprises a reflection mirror 137 and a transparent lens 138. The reflection mirror 137 is used to alter the light travelling direction, and the transparent lens 138 utilizes the principle shown in FIG. 1 to focus the light onto the image sensor 132. As a result, the image sensor 132 can receive data of the document 140.

The conventional optical system has to rely on the transparent lens to magnify or scale down the actual image in order to fit it onto the image sensor. The conventional optical system is restricted to a focal distance between the object and the transparent lens. Therefore, either the focal distance is designed to be a fixed distance when the transparent lens is integrated or the transparent lens has to be specifically designed in order to vary the focal distance. However, the fixed type of transparent lens limits the image optical system to a certain size. On the other hand, a specifically designed transparent lens will cost more. Furthermore, the transparent lens produces dispersion effects, leading to a reduction in the quality of the image.

### SUMMARY OF THE INVENTION

The present invention provides an optical system with a concave mirror for a scanner. The present invention utilizes a curved mirror as a focal device to focus the image instead of using the conventional transparent lens. Thus, the present invention can eliminate the dispersion effect caused by the transparent lens and provide a simplified structure that is easily integrated.

The present invention provides an optical system with a concave mirror, which is applicable for a scanner. The optical system comprises at least a curved reflection mirror and an image sensor. The curved reflection mirror reflects an image of an object onto the image sensor.

In one of the preferred embodiments of the present invention, the curved reflection mirror can comprise a convex surface or a concave surface. If it is desirable, the image can be altered by at least a planar reflection mirror to adjust the angle of incidence of the image and the image position onto the curved reflection mirror.

The present invention further provides another embodiment that utilizes various designs of curved reflection mirrors to achieve image formation. For example, a curved reflection mirror with a fixed radius of curvature can be used or a curved reflection mirror with a changeable radius of curvature can also be used or a curved reflection mirror having regions with various radii of curvature can even be used.

The present invention further provides an optical system with a concave mirror comprising a planar reflection mirror, a curved reflection mirror and an image sensor. The image sensor is located on a surface of an optical axis of the curved reflection mirror. An image is reflected by the planar mirror to the curved reflection mirror. The curved reflection mirror reflects the image to the image sensor.

The present invention further provides an optical system with a concave mirror comprising a curved reflection mirror, a plurality of planar reflection mirrors and an image sensor. The planar reflection mirrors are located on both sides of a surface of an optical axis of the curved reflection mirror. Due to an arrangement of the planar reflection mirrors, a space is formed closely to the surface of the optical axis. An image of an object is reflected by the planar reflection mirrors to the curved reflection mirrors. The image is then reflected by the curved reflection mirror passing through the space to the image sensor.

The present invention further provides an optical system with a concave mirror comprising a curved reflection mirror and an image sensor. The image sensor is located on a surface of an optical axis of the curved reflection mirror. The curved reflection mirror reflects an image to the image sensor.

The present invention further provides an optical system with a concave mirror capturing an image from an object that has a desired surface. The optical system comprises a planar reflection mirror, a curved reflection mirror and an image sensor. A surface of an optical axis of the curved reflection mirror is at an angle to the desired surface of the object. The image of the object is reflected by the planar mirror to the curved reflection mirror, and the image is then reflected by the curved reflection mirror to the image sensor.

From the foregoing, it can be seen that the present invention utilizes curved reflection mirrors in the optical system instead of the transparent lens. Therefore, the present invention eliminates the dispersion effect caused by the transparent lens. Furthermore, the image reflected by the curved reflection mirror is not restricted to the focal distance. Therefore, the size of the whole optical system can be reduced.

Both the foregoing general description and the following detailed description are exemplary and explanatory only and are not restrictive of the invention, as claimed.

### BRIEF DESCRIPTION OF THE DRAWINGS

The accompanying drawings are included to provide a further understanding of the present invention, and are incorporated in and constitute a part of this specification. The drawings illustrate embodiments of the invention and, together with the description, serve to explain the principles of the invention. In the drawings,

FIG. 1A is a schematic view showing an arrangement using a transparent lens.

FIG. 1B is a schematic view of an optical system inside a conventional scanner.

FIG. 2 is a schematic view of an image optical system in accordance with a preferred embodiment of the present invention.

FIG. 3 is a schematic view an image optical system in accordance with another preferred embodiment of the present invention.

FIG. 4 is a schematic view of an image optical system in accordance with another preferred embodiment of the present invention.

FIG. 5 is a schematic view of an image optical system in accordance with another preferred embodiment of the present invention.

FIG. 6A shows schematically a top view, a front view and a side view of a first type of a curved reflection mirror.

FIG. 6B shows schematically a top view, a front view and a side view of a second type of a curved reflection mirror

FIG. 6C shows schematically a top view, a front view and a side view of a third type of a curved reflection mirror

FIG. 6D shows schematically a top view, a front view and a side view of a fourth type of a curved reflection mirror

FIG. 7A is a portion view showing radius of curvature of a curved reflection mirror with a concave surface in accordance with a first preferred embodiment of the present invention

FIG. 7B is a portion view showing radius of curvature of a curved reflection mirror with a concave surface in accordance with a second preferred embodiment of the present invention.

FIG. 7C is a portion view showing radius of curvature of a curved reflection mirror with a concave surface in accordance with a third preferred embodiment of the present invention

FIG. 8 is a portion view of a curved reflection mirror with a concave surface in accordance with a preferred embodiment of the present invention.

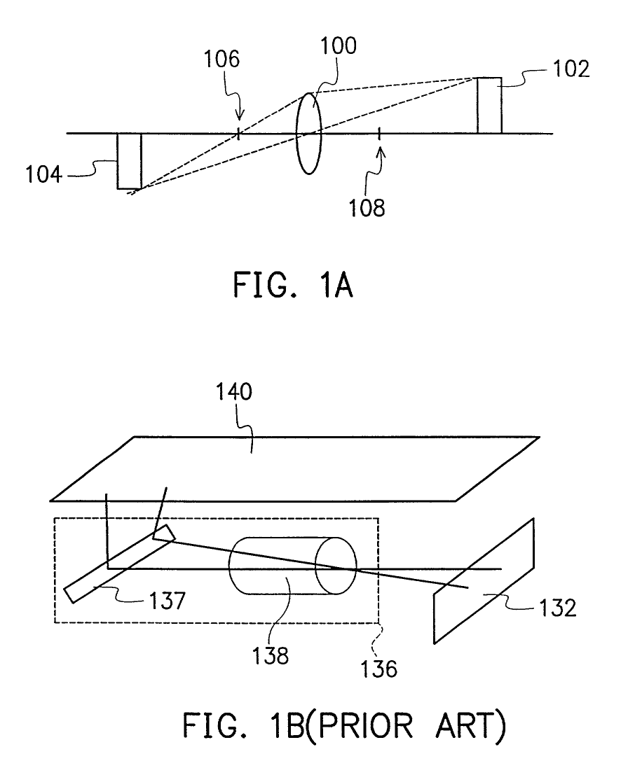

### DESCRIPTION OF THE PREFERRED EMBODIMENTS

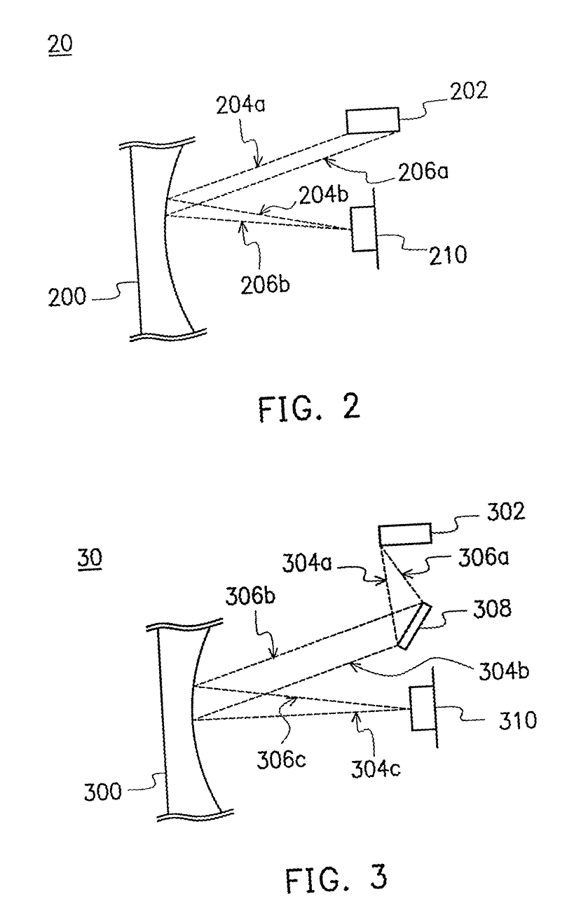

Referring to FIG. 2, showing a schematic view of an image optical system in accordance with a preferred embodiment of the present invention. An image optical system 20 includes an image sensor 210 and a curved reflection mirror 200 having a concave surface towards an object 202. The object 202 is used as a source of an image for the image optical system 20. The image optical system 20 receives incident light 204a and 206a from the object 202 first, the incident light 204a and 206a are then reflected by the concave surface of the curved reflection mirror 200 to produce reflected light 204b and 206b, which is transmitted to the image sensor 210. Although FIG. 2 shows only a diagrammatic view of the curved reflection mirror 200, reflection points of the incident light 204a and 206a on the concave surface of the curved reflection mirror 200 are close to an optical axis (not shown) of the curved reflection mirror 200.

The concave surface of the curved reflection mirror 200 is used as an example to demonstrate an image formation of the image optical system 20 according to the preferred embodiment of the present invention. However, the image optical system of the present invention is not limited to the concave surface of the curved reflection mirror only. As a matter of fact, a convex surface of a curved reflection mirror can also be used to achieve the same result as the concave surface of the curved reflection mirror.

The present invention provides another preferred embodiment by utilizing a planar mirror to alter a reflection position and a reflection angle of an image reflecting on a curved reflection mirror. Referring to FIG. 3, showing a schematic view of an image optical system in accordance with another preferred embodiment of the present invention. Once incident light 304a and 306a from an object 302 enters an image optical system 30, the incident light 304a and 306a is reflected by a planar mirror 308 to produce reflected light 304b and 306b. The reflected light 304b and 306b is then reflected again by a concave surface of a curved reflection mirror 300 to produce reflected light 304c and 306c, which is received by an image sensor 310. Similar to the previous embodiment, reflection points of the reflected light 304b and 306b on the concave surface of the curved reflection mirror 300 are close to an optical axis (not shown) of the curved reflection mirror 300.

The above-embodiment utilizes one planar mirror for the purpose of reflection, however, the technique of the present invention is not restricted to one planar mirror. As a matter of fact, several planar mirrors can be utilized to alter the angle of incidence of the image and the image position onto the curved reflection mirror.

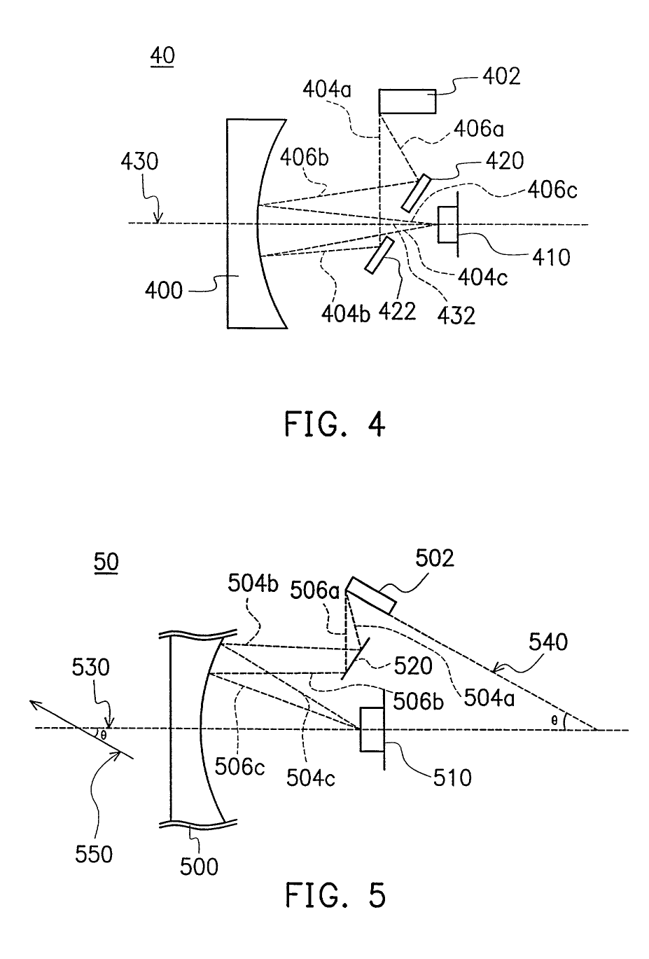

FIG. 4 illustrates a schematic view of an image optical system in accordance with another preferred embodiment of the present invention. An image optical system 40 includes an image sensor 410, planar mirrors 420, 422 and a curved reflection mirror 400 with a concave surface facing an object 402. The image sensor 410 is located on a surface of an optical axis 430 of the curved reflection mirror 400. The planar mirrors 420 and 422 are placed on both sides of the surface of the optical axis 430, as a result, a space 432 exists between the two planar mirrors 420, 422. Incident light 404a and 406a from the object 402 is reflected respectively by the planar mirrors 422 and 420 to produce reflected light 404b and 406b. The reflected light 404b and 406b is then reflected by the concave surface of the curved reflection mirror 400 to produce reflected light 404c and 406c. The reflected light 404c and 406c, reflected by the curved reflection mirror 400, passes through the space 432 to arrive at the image sensor 410.

FIG. 5 shows a schematic view of an image optical system in accordance with another preferred embodiment of the present invention. Referring to FIG. 5, an image optical system 50 comprises an image sensor 510, a planar reflection mirror 520 and a curved reflection mirror 500 having a concave surface. Incident light 504a and 506a from an object 502 is reflected on the planar reflection mirror 520 to produce reflected light 504b and 506b. The reflected light 504b and 506b is reflected again on the concave surface of the curved reflection mirror 500 to produce reflected light 504c and 506c. The reflected light 504c and 506c is received by the image sensor 510. The difference between this embodiment compared to the previous embodiments is the position of the object 502. FIG. 5 shows that the object 502 is arranged in such a way that a surface 540 of the object 502 is at an angle θ to a surface of the optical axis 530 of the curved reflection mirror 500. Even if the surface of the object 502 is not parallel to the surface of the optical axis 530 of the curved reflection mirror, the image optical system of the present invention can still be applied.

When the present invention is utilized for a movable image optical system, such as a scanner device, the image optical system 50 will have to be moved along a direction 550, which is also at an angle θ to the surface of the optical axis 530 of the curved reflection mirror 500. FIG. 5 illustrates only a portion of curved reflection mirror 500 that is close to the optical axis 530, however, the diagrammatic view of the curved reflection mirror 500 shown on FIG. 5 cannot represent the actual size of the curved reflection mirror 500.

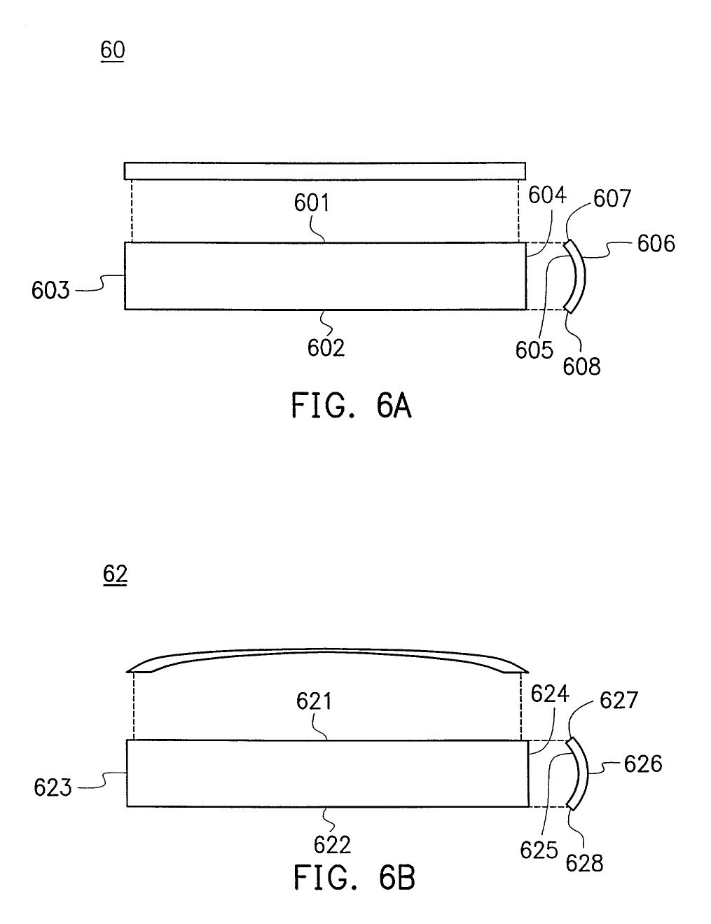

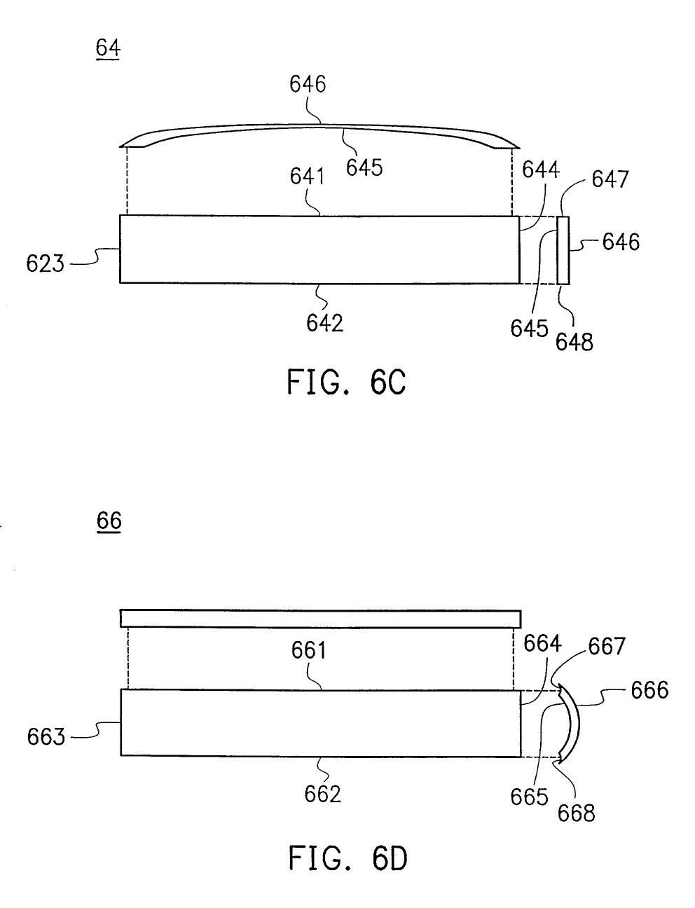

There are various types of reflection mirrors that can be utilized in the image optical system of the present invention. FIG. 6A shows schematically a top view, a front view and a side view of a first type of a reflection mirror. Referring to FIG. 6A, a curved reflection mirror 60 has long sides 601, 602, short sides 603, 604, bottom sides 607, 608 and reflection surfaces 605, 606. The short sides 603 and 604 of the curved reflection mirror 60 are bent in such a way that the reflection surface 605 becomes a concave surface and the reflection surface 606 becomes a convex surface.

FIG. 6B illustrates schematic views of a top view, a front view and a side view of a second type of a curved reflection mirror. Referring to FIG. 6B, a curved reflection mirror 62 comprises long sides 621, 622, short sides 623, 624, bottom sides 627, 628 and reflection surfaces 625, 626. The long sides 621, 622 and the short sides 623, 624 of the curved reflection mirror 62 are bent, as a result, the reflection surface 625 becomes a concave surface and the reflection surface 626 becomes a convex surface.

FIG. 6C shows schematic views of a top view, a front view and a side view of a third type of a curved reflection mirror. Referring to FIG. 6C, a curved reflection mirror 64 comprises long sides 641, 642, short sides 643, 644, bottom sides 647, 648 and reflection surfaces 645, 646. The long sides 641 and 642 of the curved reflection mirror 64 are bent in such a way that the reflection surface 645 becomes a concave surface and the reflection surface 646 becomes a convex surface.

FIG. 6D shows schematic views of a top view, a front view and a side view of a fourth type of a curved reflection mirror. Referring to FIG. 6D, a curved reflection mirror 66 comprises long sides 661, 662, short sides 663, 664, bottom sides 667, 668 and reflection surfaces 665, 666. The short sides 663, 664 and the bottom sides 667, 668 of the curved reflection mirror 66 are bent in such a way that the reflection surface 665 becomes a concave surface and the reflection surface 666 becomes a convex surface.

The above-descriptions of the curved reflection mirrors shown on FIGS. 6A-6D are used as exemplary to demonstrate that different types of curved reflection mirrors can be used in the present invention. However, the image optical system of the present invention is not limited to these certain types of the curved reflection mirrors only, a wide range of curved reflection mirrors are applicable to the present invention. For example, regard the long side of the curved reflection mirror as an X axis, the short side as a Y axis and the bottom side as a Z axis. From FIG. 6A, the first type of the curved reflection mirror with the concave surface is formed if the Y axis is bent. Similarly, by bending the X axis and the Y axis, the second type of the curved reflection mirror shown on FIG. 6B can be formed. If the X axis is bent, the third type of the curved reflection mirror shown on FIG. 6C is formed, and if the Z and Y axes are bent, then the fourth type of the curved reflection mirror shown on FIG. 6D can be formed. To those skilled in the art, any one of the above-mentioned axes, or a combination of two axes or even a combination of three axes, can be utilized to form various shapes of the curved reflection mirrors with concave surfaces. Those various shapes of the curved reflection mirrors can all be used for the image optical system of the present invention to achieve the image formation.

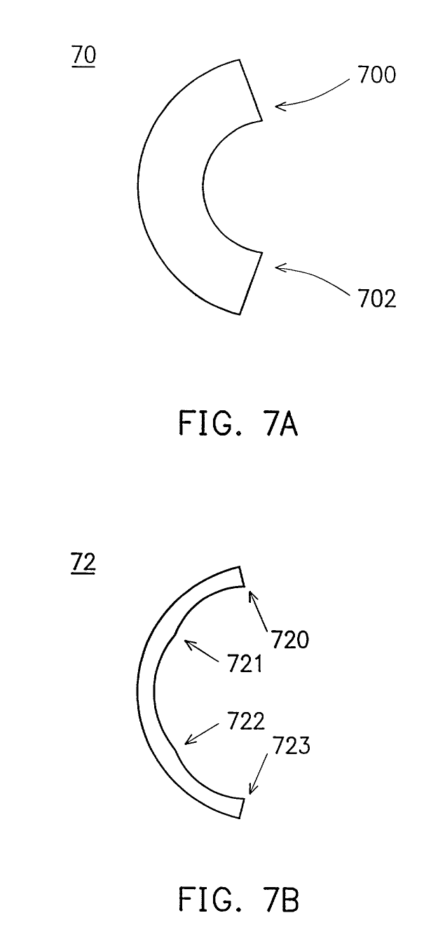

FIG. 7A illustrates a portion view showing radius of curvature of a reflection mirror with a concave surface in accordance with a first preferred embodiment of the present invention. Referring to FIG. 7A, the radii of curvature along a concave portion 700-702 of a curved reflection mirror 70 are the same.

FIG. 7B illustrates a portion view showing radius of curvature of a curved reflection mirror with a concave surface in accordance with a second preferred embodiment of the present invention. Referring to FIG. 7B, the radii of curvature along a concave portion 720-723 of a curved reflection mirror 72 are not the same. A first concave portion 720-721 with a radius of curvature R1, a second concave portion 721-722 with a radius of curvature R2 and a third concave portion 722-723 with a radius of curvature R3 are combined together to form the concave portion from 720 to 723. Although the concave portion of the curved reflection mirror used in this embodiment is divided into three portions having different radii of curvature, the concave portion of the present invention is not restricted to being divided into three portions only. The radii of curvature on these portions do not necessarily have to all be different.

FIG. 7C shows a view showing the radius of curvature of a portion of a curved reflection mirror with a concave surface in accordance with a third preferred embodiment of the present invention. Referring to FIG. 7C, a concave portion along 740 to 742 of a curved reflection mirror 74 changes its radii of curvature continuously. The radii of curvature of the concave portion can be increased moving along 740 to 742 or decreased along 740 to 742, or even in a combination of increasing and decreasing patterns. Furthermore, a combination of the curved reflection mirrors shown in FIGS. 7B-7C can be used in the present invention.

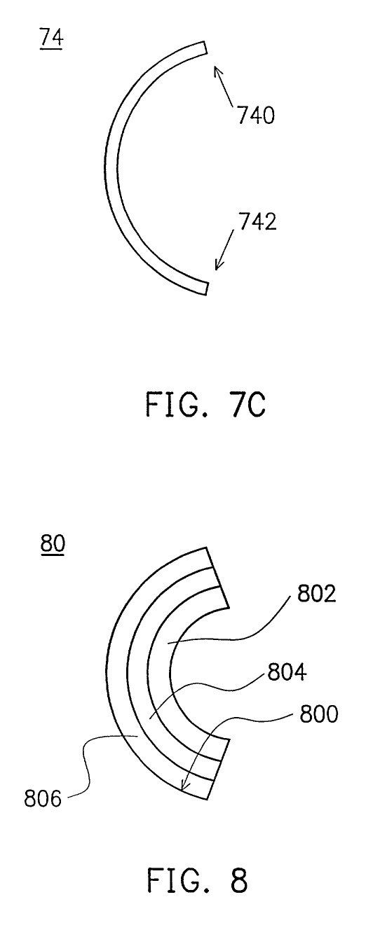

FIG. 8 shows a view of a portion of a curved reflection mirror in accordance with a preferred embodiment of the present invention. A curved reflection mirror 80 comprises three transparent layers 802, 804 and 806. The transparent layers 802, 804 and 806 are arranged closely with each other and each transparent layer has a different index of refraction. Light enters into the three transparent layers 802, 804, and 806, and is refracted sequentially by the transparent layers 802, 804 and 806. The refracted light is then reflected by a reflection surface 800 to produce a reflected light. The reflected light is refracted again sequentially by the three transparent layers 802, 804, 806 to arrive at an image sensor.

The present invention provides an image optical system that is applicable for at least one curved reflection mirror having a concave surface. To prevent a distortion image, the various types of curved reflection mirrors mentioned as above can be combined to solve the distortion problem or a software method can be used to correct the image distortion.

The present invention provides an image optical system that can eliminate dispersion effect caused by the transparent layers. Furthermore, the present invention can reduce the size of the whole image optical system.

Other embodiments of the invention will appear to those skilled in the art from consideration of the specification and practice of the invention disclosed herein. It is intended that the specification and examples are to be considered as exemplary only, with a true scope and spirit of the invention being indicated by the following claims.

What is claimed is:

1. An optical system device with a concave mirror, applicable for a scanner, comprising:
a curved reflection mirror; and
an image sensor, wherein an image is reflected by the curved reflection mirror to reach the image sensor.

2. The device of claim 1, wherein the curved reflection mirror has a concave surface.

3. The device of claim 1, wherein the curved reflection mirror has a convex surface

4. The device of claim 1, wherein the image sensor is a charge couple device (CCD).

5. The device of claim 1, wherein the image sensor is a contact image sensor (CIS).

6. The device of claim 1, wherein the optical system device further comprises a planar reflection mirror, and the image is reflected by the planar reflection mirror to the curved reflection mirror.

7. The device of claim 1, wherein the curved reflection mirror has a fixed radius of curvature.

8. The device of claim 1, wherein the curved reflection mirror has a changeable radius of curvature.

9. The device of claim 1, wherein the curved reflection mirror has fixed radii of curvature.

10. The device of claim 1, wherein the curved reflection mirror comprises three sets of sides, wherein:
a first set having two long sides;
a second set having two short sides; and
a third set having two bottom sides, wherein one of these sets of the curved reflection mirror is bent to form a desired shape of a curved reflection mirror.

11. The device of claim 1, wherein the curved reflection mirror comprising three sets of sides, wherein:
a first set having two long sides;
a second set having two short sides; and
a third set having two bottom sides, wherein two of these sets of the curved reflection mirror are bent to form a desired shape of a curved reflection mirror.

12. The device of claim 1, wherein the curved reflection mirror comprising:
two long sides;
two short sides; and
two bottom sides, wherein all sides of the curved reflection mirror are bent to form a desired shape of a curved reflection mirror.

13. The device of claim 1, wherein the curved reflection mirror comprises:
at least a transparent layer; and
a reflection mirror.

14. The device of claim 1, wherein the curvy reflection mirror comprising:
a plurality of transparent layers, each of the plurality of transparent layers having different index of refraction from others; and
a reflection mirror.

15. An optical system device with a concave mirror, applicable for a scanner, comprising:
a curved reflection mirror;
a plurality of planar reflection mirrors, locating at both sides of a surface of an optical axis of the curved reflection mirror in such a way that a space is formed close to the surface of the optical axis; and
an image sensor, located on the surface of the optical axis of the curved reflection mirror, wherein an image is reflected by the planar mirrors to the curved reflection mirror, the image is then reflected by the curved reflection mirror passing through the space to reach the image sensor.

16. An optical system device with a concave mirror, applicable for a scanner, comprising:
a curved reflection mirror; and
an image sensor, located on a surface of an optical axis of the curved reflection mirror, wherein an image is reflected by the curved reflection mirror to reach the image sensor.

17. An optical system device with a concave mirror, applicable for a scanner, wherein the device is used to receive an image from an object that has a desired surface, the device comprising:
a planar reflection mirror, reflecting the image;
a curved reflection mirror, wherein a surface of an optical axis of the curved reflection mirror is at an angle to the desired surface of the object; and
an image sensor, wherein the image of the object is reflected by the planar mirror to the curved reflection mirror, the image is then reflected by the curved reflection mirror to the image sensor.

18. The device of claim 17, wherein the image optical system device is moved along a direction which is parallel to the desired surface of the object.
